(19) United States
(12) Patent Application Publication
(10) Pub. No.: US 2003/0206549 A1
(43) Pub. Date: Nov. 6, 2003

(54) Method and apparatus for multicast delivery of information

(76) Inventors: Sachin Satish Mody, Lawrenceville, NJ (US); Kumar Ramaswamy, Plainsboro, NJ (US); Jeffrey Allen Cooper, Rocky Hill, NJ (US); John William Richardson, Hamilton, NJ (US)

Correspondence Address: JOSEPH S. TRIPOLI, THOMSON MULTIMEDIA LICENSING INC., 2 INDEPENDENCE WAY, SUITE #2, P. O. BOX 5312, PRINCETON, NJ, 08543-5312, US

(21) Appl. No.: 10/372,531

(22) Filed: Feb. 24, 2003

Related U.S. Application Data
(60) Provisional application No. 60/377,912, filed on May 3, 2002.

(51) Int. Cl. H04L 12/56

(52) U.S. Cl. 370/390

(57) ABSTRACT

A method, apparatus and data structure are described which enables complete datagram reception by a plurality of clients using a UDP multicast transport mechanism, wherein missing packets are retransmitted from a server using either a multicast transport mechanism or a unicast connection, in response to receipt by the server of client request to retransmit. Data structure of packets includes a new sequence identifier field in the header for identification of proper packet position within a data stream.

### CROSS REFERENCE TO RELATED APPLICATIONS

This patent application claims the benefit of U.S. Provisional Application serial No. 60/377,912, filed May 3, 2002, which is incorporated herein by reference in its entirety.

### FIELD OF THE INVENTION

The invention relates generally to the field of communication systems. More particularly, the invention relates to facilitating a guaranteed delivery of information stream packets via the User Datagram Protocol (UDP).

### BACKGROUND OF THE INVENTION

The UDP (User Datagram Protocol) is a communications protocol that offers a limited amount of service when messages are exchanged between computers in a network that uses the Internet Protocol (IP). UDP is an alternative to the Transmission Control Protocol (TCP) and, like TCP, uses the IP to get a data unit known as a datagram or packet from one computer to another. Unlike TCP, UDP does not provide the service of dividing a message into packets (datagrams) and reassembling it at the other end. Specifically, UDP doesn't provide sequencing of the packets that the data arrives in. Therfore, if the data is sent over a variable delay network, then the application program that uses UDP must ensure that the entire message has arrived and is in the proper order.

Transmission of packets using UDP is inherently unreliable, since UDP is a connectionless protocol and does not include a built-in mechanism to guarantee packet delivery or the order in which delivered packets are arranged. Specifically, UDP packets are not acknowledged by the receiver and there is no retransmission mechanism like TCP, to ensure that the packets are delivered.

Within the context of an information server such as a video server that is multicasting video streams to a plurality of clients, it is important to ensure that each of the clients receive all of the packets or datagrams transmitted thereto. Failure to receive any of the packets or datagrams results in presentation anomalies or artifacts deemed undesirable (e.g., dropped frames, lip sync errors, and the like). When sending data simultaneously to a plurality of clients, there are three different methods that can be used. First, packets can be sent to a well-known IP broadcast address. Second, the packets can be sent directly to each client using unicast connections Third, the packets can be sent to a multicast address that comprises a specific group of users. Multicasting of packets affords the most bandwidth efficient solution. UDP is the protocol used for multicasting of datagrams, but it is unreliable for the reasons previously described.

### SUMMARY OF THE INVENTION

The invention enables the reception of packets or datagrams by a plurality of clients via a UDP multicast transport mechanism. During a multicast distribution each client “listens” to the same UDP multicast address for incoming data. Each packet that is received by a client from a multicast group has sequence numbers associated with it, the sequence numbers being used to determine whether the packets are being delivered in the appropriate sequence. When a discrepancy in the sequence number order exists from one packet to the next packet received, intervening packet(s) may have been lost, or alternatively, received out of order. A back channel may be utilized to request retransmission of the missing packets from the server. The retransmission is preferably done via a unicast channel using a TCP connection. Optionally, multicast-based UDP retransmission is used if, for example, multiple clients are missing the same packet(s).

One embodiment of the invention is a method which comprises the acts of transmitting a data stream to a plurality of clients via a multicast communication session, the data stream comprising a plurality of data packets arranged in a predefined sequence. Each of the plurality of data packets has associated with it a sequence identifier for identifying a respective sequence position. If a retransmission request from a client is received for retransmission of a previously transmitted data packet, then the requested data packet is retransmitted to the client via a reliable unicast connection or multicast mechanism.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of an information distribution system in accordance with the principles of the present invention;

FIG. 2 depicts a high-level block diagram of a controller suitable for implementing a video server and/or client within the information distribution system of FIG. 1, and in accordance with the principles of the present invention;

FIG. 3 depicts an exemplary data structure in accordance with the principles of the present invention;

FIG. 4 depicts a flow diagram of a client-side packet processing routine in accordance with the principles of the present invention; and

FIG. 5 depicts a flow diagram of an exemplary method in accordance with the principles of the present invention.

To facilitate understanding, identical reference numerals have been used, whenever possible, to designate identical elements that are common to the figures.

### DETAILED DESCRIPTION OF THE INVENTION

The invention is discussed within the context of an information distribution system such as a video distribution system. However, it will be appreciated by those skilled in the art that the teachings of the present invention may be readily adapted to any information distribution system in which relatively large information streams or files such as video streams, audio streams, large blocks of data and the like are transferred to a plurality of clients using UDP.

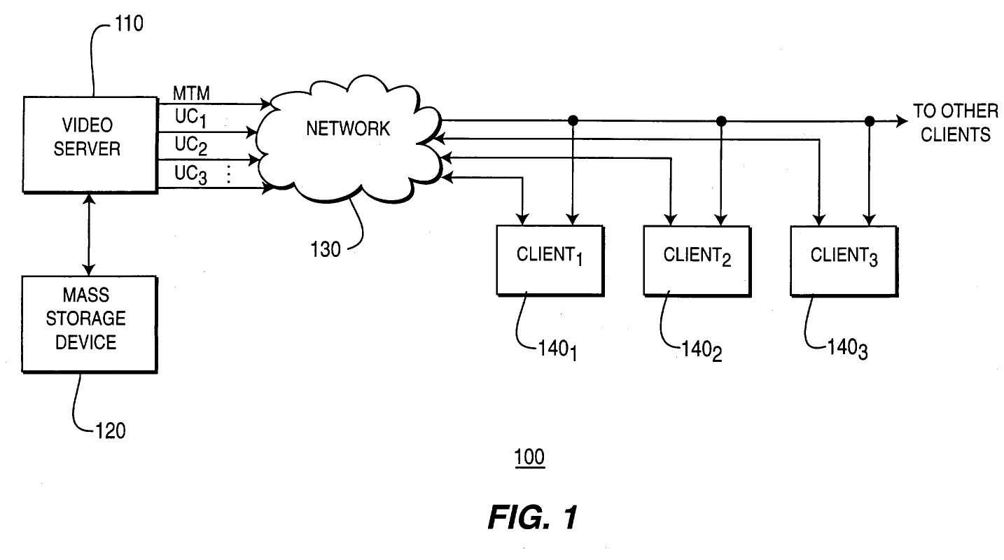

FIG. 1 depicts a high-level block diagram of an information distribution system 100. Specifically, the information distribution system 100 of FIG. 1 comprises a video server 110, a mass storage device 120, a network 130, and a plurality of clients denoted as 140₁, 140₂, 140₃ and so on (collectively referred to as clients 140).

The network 130 comprises, illustratively, an Internet protocol (IP) network such as the Internet. The network 130 is depicted as facilitating communications between the video server 110 and clients 140 via a multicast transport mechanism (MTM) and a plurality of unicast connections (UC₁ through UCₙ). That is, the MTM and UC channels are connectionless communications channels in that information passed between the video server 110 and clients 140 via the network 130 does not necessarily travel via identical routes. Rather, IP addresses associated with each packet are used to direct packets via the connectionless network 130 to the intended recipient of the packet. The multicast channel is typically utilized for the transmission of a plurality of packets having multiple intended recipients; whereas the unicast channel(s) are utilized for the transmission of packets that have a single intended recipient.

The mass storage device 120 stores one or more information streams such as those subsequently described with respect to FIG. 3. For example, the mass storage device 120 may comprise a redundant array of inexpensive disks (RAID) storage device for storing a plurality of encoded files for use as multimedia or audio/visual streams (such as MPEG streams, for example). Each of the information streams stored as files in the mass storage device 120 is preprocessed to facilitate transport to clients via the network 130. The preprocessing comprises dividing each of the information stream files into a plurality of portions and encapsulating these portions within respective data structures, in accordance with the principles of the present invention. In an embodiment of the present invention utilized for multimedia data (audio and/or video), each of the information stream portions is included within the payload portion of a real-time transport protocol packet. Real-Time Transport Protocol (RTP) is an IP standard that specifies a way for applications to carry real-time transmission of multimedia data over either unicast or multicast network services. RTP does not in itself guarantee real-time delivery of multimedia data (since this is dependent on network characteristics).

Since the server assigns each packet a sequence number, for large volumes data (such as an entire movie clip), at least a 3-byte sequence number field would be utilized. This would require an additional 3-byte sequence number field to be added to the generic RTP header to determine the relative position of the information stored in the payload. Of course, even larger streamed data files would require an even larger sequence number field, while smaller streamed data files could utilize a smaller sequence number field; as would be understood by those skilled in the art.

The video server 110, as with each of the clients 140, has associated with it a unique IP address. Using the various IP addresses, the video server 110 and clients 140 are able to communicate control information, information stream requests and the like using the standard TCP connections.

In operation, a video stream or other information stream stored within the mass storage device as a plurality of packets including information stream portions and minimal header information (i.e., sequence numbers and extension lengths) is transported to each of a plurality of clients 140 by the video server 110 using the multicast channel MTM through the network 130. The MTM utilizes the UDP, which, as discussed elsewhere in this disclosure, and typically does not include error correction, sequencing, guaranteed delivery and other capabilities. Each client 140 receives the information stream packet structures via the MTM and stores them for subsequent use. Since the network 130 may comprise a variable delay network, the packets may not arrive in the same order they were transmitted. However, packets that have not arrived after a threshold amount of time (or packet count) has expired are deemed to be missing by a client that has not received the packet. In this instance, the client opens a TCP connection or sends a UDP packet to the video server and requests retransmission of the missing packet(s). The video server 110 transmits the missing packet(s) to the requesting client via a UC. After a client has received all the packets necessary to provide the transmitted information stream, the client sorts the received packets according to the sequence numbers associated therewith (discarding duplicate packets) to retrieve the transmitted information stream. Alternatively, the sorting process may be performed during the transmission process where sufficient buffering is provided to enable missing packet detection, requests for retransmission and actual retransmission of the missing packets to occur. In this manner, a streaming video or other information stream may be provided.

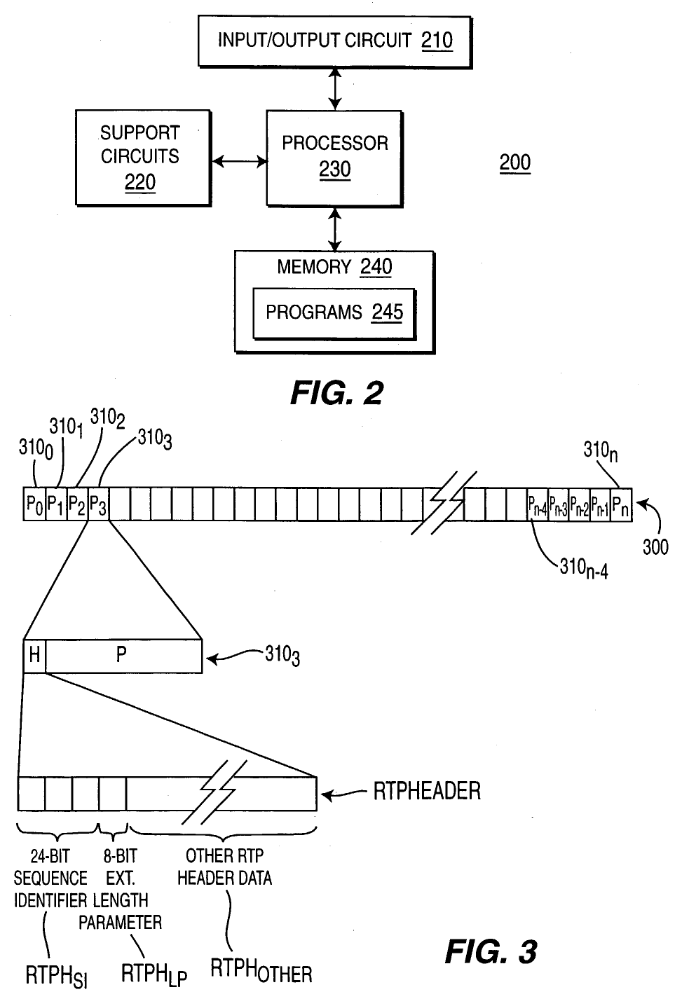

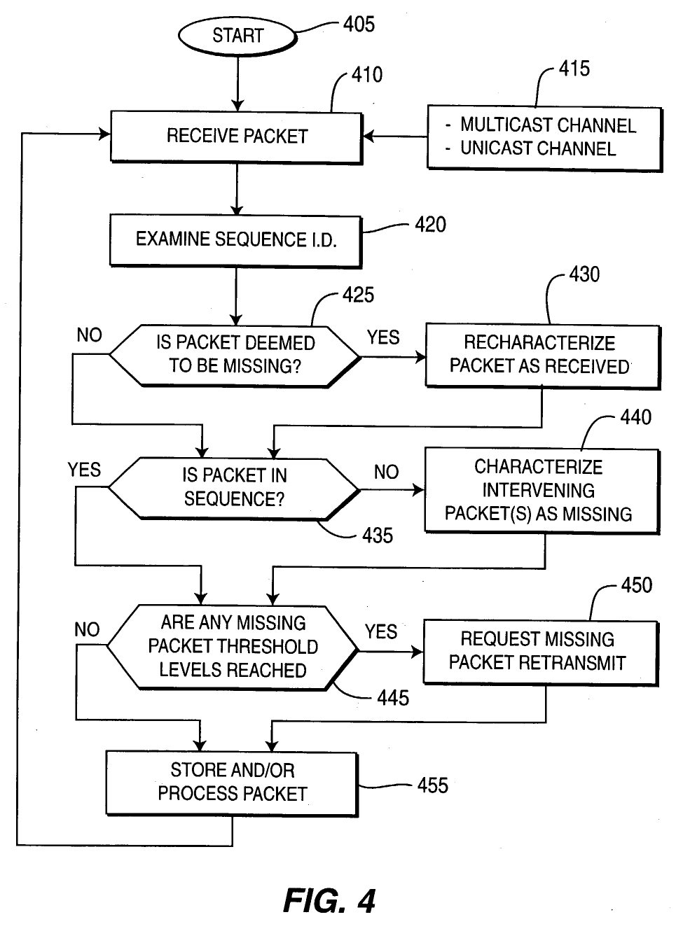

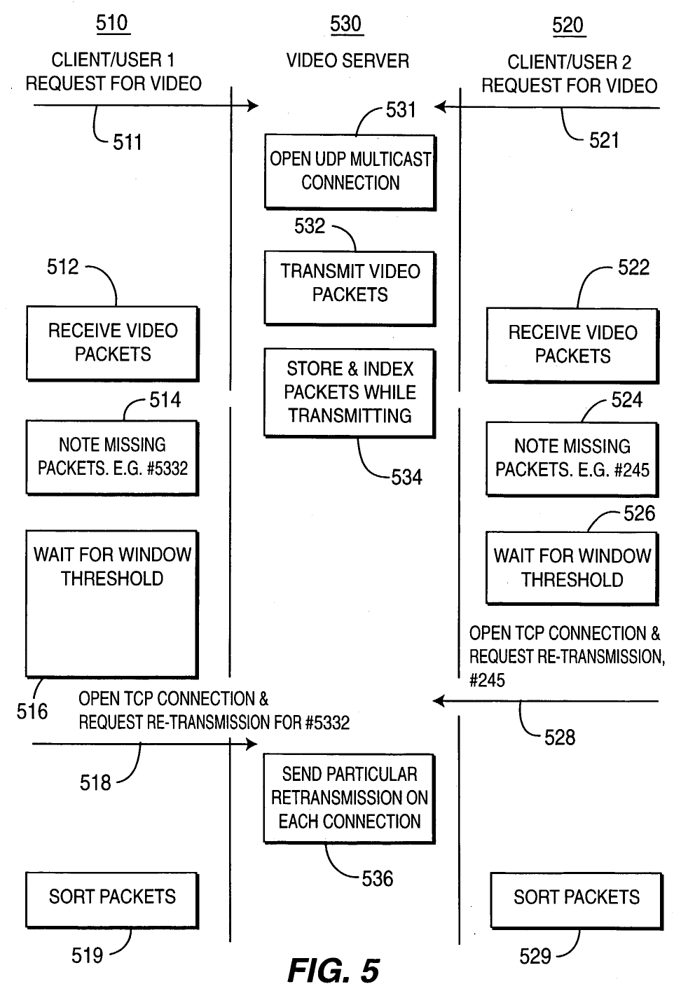

FIG. 2 depicts a high-level block diagram of a controller suitable for use in the communication system of FIG. 1. Specifically, the controller 200 of FIG. 2 is suitable for use in implementing server functionality, client functionality and/or system management functionality such as discussed herein. For example, the controller 200 of FIG. 2 may be adapted to perform the various processes associated with the video server 110, any of the clients 140 and/or a network manager (not shown). For example, a controller 200 implementing the functionality of a video server 110 may perform such tasks as arranging content streams, audiovisual streams or other information streams according to the data structures of the present invention. Similarly, the controller 200 adapted to implement functionality of a client 140 may perform various method steps such as discussed below with respect to FIGS. 4 and 5.

The exemplary controller 200 of FIG. 2 comprises a processor 230 as well as memory 240 for storing various programs 245. The programs 245, when executed by the processor 230, enable the controller 200 to perform various acts, functions and/or methods in accordance with the principles of the present invention. The processor 230 cooperates with conventional support circuitry 220 such as power supplies, clock circuits, cache memory and the like, as well as circuits that assist in executing the software routine stored in the memory 240. As such, it is contemplated that some of the process steps discussed herein as software processes may be implemented within hardware, for example, as circuitry that cooperates with the processor 230 to perform various steps. The controller 200 also contains input/output (I/O) circuitry 210 that forms an interface between the various functional elements communicating with the controller 200. For example, in the case in which the controller 200 implements the functionality of the video server 110 of FIG. 1, the I/O circuitry 210 communicates with the mass storage device 120 and other functional elements within the video server 110.

Although the controller 200 of FIG. 2 is depicted as a general-purpose computer that is programmed to perform various functions in accordance with the present invention, the invention can be implemented in hardware as, for example, an application specific integrated circuit (ASIC). As such, the process steps described herein are intended to be broadly interpreted as being equivalently performed by software, hardware, or a combination thereof.

FIG. 3 depicts a data structure according to an embodiment of the present invention. Specifically, FIG. 3 depicts an information stream 300 comprising a plurality of packets or datagrams P₀ (310₀), P₁ (310₁) and so on up to Pₙ (310ₙ), collectively datagrams or packets 310. Packet P₃ (310₃), which is representative of each of the other packets 310, comprises a header portion H and a payload portion P. The payload portion P includes one or more datagrams or packets of the information stream 300. The header portion H, comprises an RTP header adapted to further include a 24 bit sequence identifier (RTPH_{SI}) field and an 8 bit extension length parameter (RTPH_{LP}) field. Optionally, other RPT header data (RTPH_{OTHER}) may be used. In the instant embodiment, the RTP header is present only in case of multimedia data distribution. For example audio or video streams are intended to use the RTP payload format. However, in case of non real-time data such as a file, the RTP header is not required and may not be present. A primary requirement for the present invention is the presence of a sequence number field long enough so that the entire data file can be numbered once it is split into packets suitable for transmitting over an IP/UDP channel.

The so-called RTP header data comprises a standard or generic RTP header. Appended to the standard or generic RTP header is the sequence identifier field and the extension length field. While shown as comprising 24 bits and 8 bits, respectively, it will be appreciated by those skilled in the art that more or fewer bits may be used to achieve the same purpose. In cases where the RTP protocol is not being used, the sequence number field can be added as an extension to some other protocol header.

The sequence number field stores a number that enables the client/user 140 to keep track of each individual packet that it did not receive, such as packets lost during transmission and the like. It is noted that the information stream 300 of FIG. 3 comprises a plurality of packets 310 that are intended to be processed, decoded and/or presented in a certain order. In the instant embodiment of the present invention, the positional order in which the packets are intended to be arranged is defined by the sequence number, wherein each successive packet has a sequence number that is one greater than the immediately preceding packet.

The length of extension field identifies the length of the header portion of the packet (or extended header portion), such that the start of the payload portion and, therefore, the payload data forming the information stream, may be determined. The video server or data server stores the entire video sequence in the packetized form with the sequence numbers acting as indexing numbers. The data stored in this manner would only consist of the actual payload data, along with the 3-byte sequence numbers. Another indexing scheme would be required to index through this list as the size of the packets is not constant. This scheme helps the server to choose any individual packet to be transmitted, when a client requests a retransmission for that packet. Each packet, when received by a client, is processed according to the methods described below with respect to FIGS. 4 and 5.

FIG. 4 depicts a flow diagram of a client-side method according to the invention. Specifically, the method 400 of FIG. 4 is entered at step 405 and proceeds to step 410, where a client receives a packet via (per box 415) a multicast channel or a unicast channel. As previously discussed, information stream packets are initially broadcast to a plurality of clients via a multicast channel. In the case of missing or lost packets, such packets are transported to specific requesting clients via a unicast channel. Alternatively, missing or lost packets may be rebroadcast via the multicast channel such that the client(s) deeming a packet to be missing can utilize it while those clients having already received the packets simply ignore the new packet.

At step 420, the sequence identifier field of the received packet is examined, and at step 425 a determination is made as to whether the received packet is deemed to be missing. That is, at step 425, a determination is made as to whether the sequence ID examined at step 420 is the same as the sequence ID of a packet deemed to be missing. If the query at step 425 is answered affirmatively, then at step 430 the previously deemed missing packet is recharacterized as a successfully received packet (i.e., a non-missing packet).

At step 435, a determination is made as to whether the sequence ID of the received packet is consecutive to the sequence ID of the immediately preceding non-missing packet. That is, unless the received packet had been deemed to be missing (per step 425), the sequence ID associated with the received packet should be consecutive to the sequence ID associated with the immediately preceding packet. If this is true, then the method 400 proceeds to step 445. If this is false, then at step 440 the intervening packet(s) between the received packet and the previously received non-missing packet are deemed to be missing. For example, assuming a presently received packet has a sequence ID of 753, while the previously received packet has a sequence ID of 749, the intervening packets (750, 751, 752) would be deemed as missing packets.

At step 445, a determination is made as to whether any missing packet threshold levels have been reached. Specifically, in one embodiment of the invention, since it is entirely possible for packets to be received out of sequence in the connectionless, variable delay IP networks commonly used, a threshold level is established in terms of time or number of packets received to allow for such anomalies. At the expiration of such a threshold time or packet reception count, the client requests retransmission of the missing packet(s) by the server. For example, a one hundred packet threshold may be set wherein retransmission of a missing packet is requested by the client after the reception of 100 additional packets.

If the missing packet threshold level of step 445 has not been exceeded for any of the packets deemed to be missing, then the received packet is stored and/or processed. For example, the portion of the information stream within the received packet is extracted and aligned with previously received information stream portions. If the missing packet threshold level of step 445 has been exceeded by one or more missing packets, then at step 450 a request for retransmission of the one or more missing packets is made by the client. In the instant embodiment of the present invention, the request is made via a back channel using, for example, a standard TCP connection. In response, the server will retransmit the missing packets directly to the requesting client via a dedicated TCP connection on a separate port or by inserting the missing packets into the multicast channel being received by the plurality of clients.

At step 455, the received packet is stored and/or processed. That is, at step 455 the received packet may be stored in the order in which it was received, or in a sorted order based upon its respective sequence number. In a real-time streaming application, a plurality of packets are buffered by the client and presented prior to the reception of all packets of the information stream. In such an embodiment, the client allocates sufficient memory to store at least the payload portion of received packets in order of presentation or processing, and further to allow sufficient time to request retransmission of and reception of missing packets.

The above-described method 400 of FIG. 4 is depicted as a plurality of steps shown in a particular order. However, it will be appreciated by those skilled in the art that the various steps forming the method 400 of FIG. 4 may be performed in a different sequence and, may be performed simultaneously, or only certain of the various steps may be performed in certain embodiments. For example, the packet reception step 410 may simply comprise the examination of packets previously received and stored in an input buffer, while the storage and/or processing step 455 may be performed on packets stored within intermediate or output buffers. These steps may be performed simultaneously on different packets.

FIG. 5 depicts a flow diagram of an exemplary embodiment of a method in accordance with the principles of the present invention. Specifically, the method 500 of FIG. 5 includes processing steps performed by a first client 510, a second client 520, and a video server 530 according to the present invention. Thus, steps 511 through 519 are performed by the first client, steps 521 through 529 are performed by the second client, and steps 531 through 536 are performed by the video server.

The first client requests a video information stream at step 511, while the second client requests the same video information stream at step 521. It will be appreciated by those skilled in the art that non-video or other information streams may also have been selected. At step 531, the video server opens a UDP multicast session and, at step 532, begins transmitting video packets via the multicast session. As indicated at step 534, the video packets are stored and indexed by the video server during transmission.

At step 512, the first client begins receiving video packets, while at step 522 the second client begins receiving video packets. If there are no errors in transmission, no dropped or missing packets or other problems, the video packets forming the video information stream are received by both clients and sorted into the appropriate order for subsequent processing or presentation. Such sorting occurs at step 519 for the first client and at step 529 for the second client. The sorting function utilizes sequence numbers included within a header portion of each packet, preferably using the data structures discussed above with respect to FIG. 3, though alternative sequence number indicia may be used.

FIG. 5 depicts processing steps executed by the two clients and video server in response to a missing packet error. Specifically, at step 514, the first client notes a missing packet, for example packet number 5332. After waiting for a window threshold to expire at step 516 (e.g., 100 packets, 0.5 seconds or some other window metric), at step 518 the first client opens a TCP connection and requests retransmission of packet number 5332 from the server. At step 524, the second client notes that packet number 245 is missing and, after waiting for the expiration of a threshold window at step 526, the second client at step 528 opens a TCP connection and requests retransmission of packet number 245 from the server. At step 536, the video server retransmits the requested missing packets to each of the clients via their respective open TCP connections (not necessarily at the same time). The process of identifying and requesting missing packets is repeated as often as necessary. It is noted that in one embodiment of the invention, the missing packets are retransmitted via the multicast connection, rather than the respective open TCP connections.

An exemplary window threshold mechanism is now be described. Specifically, as previously stated, each client continuously keeps track of the sequence numbers of the packets being received. If the sequence number of a packet is not the immediate next sequence number of the previously received packet, then the client notes the sequence number(s) of the intervening packets deemed to be missing. This information may be stored in a temporary folder or storage area within the client (e.g., memory 240) and be associated with an initial setting for a threshold window. The initial setting may comprise a packet counter setting, a time counter and the like. The packet counter is incremented each time a new packet is received, such that a window of, illustratively, 100 packets may be determined with respect to particular missing packet(s).

The client continually tracks the sequence number of packets being received and if at any time a sequence number is received that is less than or smaller than the one previously received, the newly received sequence number is compared to the sequence numbers stored in a temporary folder. If a match is found with any of the numbers, then that entry is deleted from the temporary folder. At the expiration of a threshold window, those entries within the temporary folder associated with the threshold window (or all entries within the temporary folder) are deemed to be missing packets and a retransmission is requested for each of them, according to the particular retransmission system employed. In this manner, out of order delivery of packets that might occur while transmitting packets over a variable delay network such as the Internet are compensated for. Retransmission may be achieved by opening a dedicated unicast TCP connection on a separate port. The packets received by the retransmission are then inserted at their exact location, which was previously saved by the client when the packets were deemed to be lost or missing.

Prior to presenting or playing back the downloaded audio, video, multimedia, or other information stream, the received packets are sorted into their proper order. Sorting may occur as a final processing step prior to presentation, or as a processing step during transmission of packets (i.e., “on the fly” sorting). The proper sorting order is determined by the sequence numbers of the respective packets. If a duplicate copy of a packet is found, then the duplicate copy is discarded. This may occur where a packet has been delayed beyond the threshold value and a retransmission was issued prior to its arrival. This may also occur where retransmission is performed using the multicast communications channel rather than the unicast communications channel. For example, referring to FIG. 5, if the multicast communications channel is used for retransmission, then the packets lost to client 1 (e.g., packet number 5332) may not have been lost to client 2. Thus, client 2 may have received two copies of packet number 5332. Such duplication is compensated for during the sorting process.

The retransmissions can be made via a dedicated TCP unicast connection or via the existing multicast session. Alternatively another multicast retransmission session can also be used. The server can make use of a timer function to decide whether to send the retransmission over a dedicated TCP connection to a particular client or send the retransmission over the existing or dedicated retransmission multicast session. If more then one client has requested the same packet. The server would wait for a specific period of time after it receives a retransmission request for any particular packet, to see if it receives the same request from other clients as well. If multiple retransmission requests are received for the same packet before the timer expires then the packet is sent on the existing multicast session. If only a single request exists then it would be sent on a dedicated TCP connection to the requesting client.

A method to reduce the transmission overhead of a 32 bit sequence number can be used. For example, for a worst case 1500 byte IP packet, the 32 bit sequence number takes a small percentage of overhead (0.26%), however for transmission of large files (such as a long duration multimedia content), the additional overhead can be significant in terms of bytes. In the case when the loss rate of packets is low, then it is more efficient to send new sequence numbers only every N^{th} packet. The client must then count packets received between packets with a sequence number; if less than N arrived then the client will request retransmission of all N packets. Therefore, when loss occurs more data must be retransmitted. The system is preferably designed to optimize the total number of bits sent given the error rate of the channel by choosing an N. As N is increased beyond 1, the loss rate also increases. Thus, a balance is struck between the bandwidth saved by increasing N and the resulting loss rate increase.

Although various embodiments that incorporate the teachings of the present invention have been shown and described in detail herein, those skilled in the art can readily devise many other varied embodiments that still incorporate these teachings.

What is claimed is:

1. A method, comprising:
transmitting a data stream to each of a plurality of clients via a multicast communication session, said data stream comprising a plurality of data packets arranged in a predefined sequence, each of said plurality of data packets having associated with it a sequence identifier for identifying a respective sequence position;
receiving a client request for retransmission of a previously transmitted data packet; and
retransmitting said requested data packet to said requesting client via at least one of a unicast communications channel and said multicast communication session.

2. The method of claim 1, wherein said multicast communication session uses a user datagram protocol (UDP) and said unicast communications channel uses a transmission control protocol (TCP).

3. The method of claim 1, wherein each of said plurality of data packets forming said data stream further includes an extension length field.

4. The method of claim 1, wherein said client request includes information pertaining to at least one of said sequence identifiers.

5. The method of claim 1, wherein said plurality of data packets forming said data stream are comprised of real-time transport protocol (RTP) packets adapted for delivery using a user datagram protocol (UDP) via an Internet Protocol (IP) network.

6. The method of claim 5, wherein each of said plurality of data packets includes a header, said header normally including IP, UDP and RTP header information, said normally included IP, UDP and RTP header information being replaced by a sequence identifier field and a length of extension field.

7. The method of claim 1, wherein:
each of said sequence identifiers being associated with corresponding ones of said plurality of data packets; and
said step of retransmitting said requested data packet comprises retransmitting each of said plurality of data packets corresponding to each of said sequence identifiers being associated with said corresponding ones of said plurality of data packets.

8. The method of claim 7, wherein said sequence identifier is generated every N^{th} packet, said sequence identifier being associated with each of a sequence of packets including said N^{th} packet.

9. The method of claim 1, wherein data packets corresponding to said client request for retransmission is retransmitted via said unicast communications channel only.

10. A method, comprising:
receiving a data stream via a multicast communications session, said data stream comprising a plurality of data packets ordered in a predefined sequence, each of said plurality of data packets including a sequence identifier for identifying a corresponding respective sequence position;
determining, using said sequence identifiers, whether ones of said plurality of data packets are missing from said data stream; and
receiving missing ones of said plurality of data packets via a unicast communications channel.

11. The method of claim 10, further comprising:
requesting retransmission of said missing ones of said plurality of data packets after at least one of:
a threshold time expiration, and
a reception count reaching a threshold level.

12. The method of claim 11, wherein said step of requesting retransmission is launched via a transmission control protocol (TCP) connection.

13. The method of claim 12, wherein said step of requesting retransmission utilizes a user datagram protocol (UDP) packet addressed to a transmitting server.

14. The method of claim 12, wherein said step of requesting retransmission utilizes a user datagram protocol (UDP) packet addressed to a multicast group address monitored by a transmitting server.

15. The method of claim 12, wherein said step of requesting retransmission is a request for retransmission of at least one missing data packet associated with at least one corresponding sequence identifier.

16. A data structure, comprising:
a plurality of Real-Time Transport Protocol (RTP) packets having respective header (H) and payload (P) portions, each of said RTP packets including a sequence identifier (RTPH_{SI}) within a respective header portion for identifying a respective location within an information stream.

17. The data structure of claim 16, wherein said header portion comprises an RTP-compliant header portion extended to include a first additional field (RTPH_{SI}) for storing said sequence identifier, and a second additional field (RTPH_{LP}) for storing an extension length parameter, said extension length parameter indicative of the length of the extension to the header portion.

18. A apparatus comprising:
means for transmitting a data stream to each of a plurality of clients via a multicast communication session, said data stream comprising a plurality of data packets arranged in a predefined sequence, each of said plurality of data packets having associated with it a sequence identifier for identifying a respective sequence position;
means for receiving a client request for retransmission of a previously transmitted data packet; and
means for retransmitting said requested data packet to said requesting client via at least one of a unicast communications channel and said multicast communication session.
